(19) United States
(12) Patent Application Publication
(10) Pub. No.: US 2006/0268762 A1
(43) Pub. Date: Nov. 30, 2006

(54) Method of path monitoring in a wireless communication system

(76) Inventors: Francis Dominique, Rockaway, NJ (US); Hongwei Kong, Denville, NJ (US)

Correspondence Address: HARNESS, DICKEY & PIERCE, P.L.C., P.O. BOX 8910, RESTON, VA, 20195, US

(21) Appl. No.: 11/136,441

(22) Filed: May 25, 2005

(51) Int. Cl. H04L 1/00

(52) U.S. Cl. 370/328; 370/252

(57) ABSTRACT

In the method, a condition for a propagation path is determined based at least in part on an adjusted path condition threshold, the adjustment based at least in part on a signal parameter of a signal received from a mobile on the propagation path.

### BACKGROUND OF THE INVENTION

1. Field of the Invention

The present invention relates generally to a wireless communication system, and more particularly, to a method of path monitoring in a wireless communication system.

2. Description of the Related Art

A cellular communications network typically includes a variety of communication nodes coupled by wireless or wired connections and accessed through different types of communications channels. Each of the communication nodes includes a protocol stack that processes the data transmitted and received over the communications channels. Depending on the type of communications system, the operation and configuration of the various communication nodes can differ and are often referred to by different names. Such communications systems include, for example, a Code Division Multiple Access 2000 (CDMA2000) system and a Universal Mobile Telecommunications System (UMTS).

Third generation wireless communication protocol standards (e.g., 3GPP-UMTS, 3GPP2-CDMA, etc.) may employ a dedicated traffic channel in the uplink (e.g., a communication flow between a mobile station (MS) or User Equipment (UE) and a base station (BS) or Node B. The dedicated traffic channel may include a data part (e.g., a dedicated physical data channel (DPDCH) in accordance with UMTS protocols, a fundamental channel or supplemental channel in accordance with CDMA2000 protocols, etc.) and a control part (e.g., a dedicated physical control channel (DPCCH) in accordance with UMTS protocols, a pilot/power control sub-channel in accordance with CDMA2000 protocols, etc.).

FIG. 1 illustrates a conventional wireless communication system 100 operating in accordance with UMTS protocols. Referring to FIG. 1, the wireless communication system 100 may include a number of Node Bs such as Node Bs 120, 122 and 124, each serving the communication needs of UEs such as UEs 105 and 110 in their respective coverage area. The Node Bs are connected to an RNC such as RNCs 130 and 132, and the RNCs are connected to a MSC/SGSN 140. The RNC handles certain call and data handling functions, such as, autonomously managing handovers without involving MSCs and SGSNs. The MSC/SGSN 140 handles routing calls and/or data to other elements (e.g., RNCs 130/132 and Node Bs 120/122/124) in the network or to an external network. Further illustrated in FIG. 1 are conventional interfaces Uu, Iub, Iur and Iub between these elements.

An example of a conventional frame structure for the uplink dedicated physical channels (e.g., DPCCH and DPDCH), is illustrated in FIG. 2. Each frame 200 may have a length of, for example, 10 milliseconds (ms) and may be partitioned into 15 slots 205. Each slot 205 may have a length of, for example, 2560 chips, which corresponds to one power-control period, and may have a duration of, for example ⅔ ms.

The uplink dedicated physical channels includes a DPDCH 240 and a DPCCH 220. Each of the DPCCH 220 and the DPDCH 240 may be code multiplexed.

The DPDCH 240 may include information transmitted from one of the mobile stations or UEs 105/110. The DPCCH 220 may include control information, for example, a pilot signal 221, transmit power control information (e.g., transmit power control (TPC) bits, which may be used or unused) 222, a transport format combination indicator (TFCI) value 223 and feedback information (FBI) 224.

The TFCI 223 may inform the Node B 120/122/124 of the transport format of information (e.g., voice and/or data packets, frames, etc.) transmitted from the UEs 105/110.

The UE 105/110 and the Node Bs 120/122/124 may generate transmit power control (TPC) commands 222 to control each others transmit power. When the UE 105/110 communicates with, for example, a single Node B 120/122/124, a single transmit power control command may be received in the TPC information 222 of each timeslot.

While FIG. 2 illustrates a 3GPP-UMTS uplink frame structure, a 3GPP2-UMTS uplink frame structure may be similar. However, a typical 3GPP2-UMTS uplink frame structure does not include the above-described TFCI 223 and FBI 224.

FIG. 3 illustrates a conventional UMTS uplink transmitter 300 (e.g., located at one of UEs 105/110 of FIG. 1) and receiver 350 (e.g., located at one of Node Bs 120/122/124 of FIG. 1). The transmitter 300 includes, for each of the DPDCH 240 and the DPCCH 220, a binary phase shift keying (BPSK) modulator 305, an orthogonal spreading unit 310, and a gain unit 315. Frames (e.g., frame 200) associated with the DPCCH 240 and the DPDCH 220 are modulated at respective BPSK Modulators 305. The modulated frames are then spread by, for example, two orthogonal codes (e.g., Walsh codes) at the respective orthogonal spreading unit 310. The spread modulated frames are received by the gain units 315 where an amplitude of the spread modulated frames may be adjusted. The outputs of each of the gain units 315 are combined (e.g., code-division multiplexed) into a combined signal by a combiner unit 320. The combined signal is scrambled and filtered by a shaping filter 325. The output of the shaping filter 325 is sent to the receiver 350 via a propagation channel 335 on a given propagation path 330.

The receiver 350 includes a matched filter unit 355 for filtering signals carried on the propagation channel 335 to attain the signal on the propagation path 330 from the transmitter 300. The filtered signal is sent to the processing block 360 to generate DPDCH soft symbols and for further processing (e.g., decoding with turbo decoders (not shown), decoding with convolutional decoders (not shown), etc.). As will be described later, the filtered signal is also sent to a multipath acquisition unit 365. The processing block 360 may generate propagation channel measurements based on signals received over the propagation channel 335. For example, a mobility of the UE 105/110 and/or received signal frame energy for the received signal on the propagation path 330 may be determined at the processing block 360. In an example, the mobility of the UE 105/110 may be determined with a mobility indicator, which may be an estimate of the bandwidth of the propagation channel 335, alternatively referred to as a Doppler spread of the propagation channel 335. Methodologies for determining the mobility indicator are well-known in the art. In another example, the received signal frame energy for the received signal on the propagation path 330 may be the DPCCH energy over a given frame (e.g., frame 200).

The processing block 360 may use information associated with the propagation path 330 (e.g., a position of the propagation path 330). This information may be acquired with processing at the multipath acquisition unit 365 and a path management unit 370. The multipath acquisition unit 365 analyzes a range of path positions, alternatively referred to as “hypotheses”, and reports on positions within the range of path positions having a high signal energy (e.g., above a given threshold) as being “available”. The path management unit 370 compares the available paths with existing path information (i.e., paths currently being monitored by the processing block 360) received from the processing block 360. Based on the comparison, the path management unit 370 removes duplicate paths from the available paths and sends the resulting path information to the processing block 360 at a given interval. Likewise, the existing path information may be received by the path management unit 370 from the processing block 360 at the given interval. In an example, the given interval may correlate to each frame (e.g., every 10 ms).

FIG. 4 illustrates a flow chart of a conventional operation 400 of the path management unit 370. The path management unit 370 receives the existing path information from the processing block 360 in step S405. The path management unit 370 analyzes and filters (e.g., removes or disables) a portion of the existing paths in step S410, as will be described later in greater detail. The timing of the remaining existing paths is adjusted in step S415. In step S420, the path management unit 370 receives the available paths from the multipath acquisition unit 365. In step S425, the path management unit 370 merges the available paths with the remaining existing paths and removes any duplicate paths (e.g., paths present in both the remaining existing paths and the available paths). The resulting path information is sent to the processing block 360 in step S430.

A conventional filtering operation 500 which may be used in step S410 will now be described with respect to FIG. 5. The conventional filtering operation 500 may determine whether a signal received on the propagation path 330 is acceptable or unacceptable based at least in part on an average of long term energy (LTE) associated with the signal, the calculation of which will be described later in greater detail. As shown, the path management unit 370 determines path frame energy (e.g., for the frame 200) for the signal received at the receiver 350 from the transmitter 300 on the propagation path of the propagation channel 335 in step S505.

The path management unit 370 calculates the LTE in step S510. The path management unit 370 may calculate the LTE using any well-known LTE calculation method (e.g., a sliding-window moving average, an infinite impulse response (IIR) filter, etc.). A current status of the propagation path 330 (e.g., whether the propagation path 330 is acceptable or unacceptable) is determined based at least in part on the calculated LTE in step S515 (step S515 is described in greater detail below with respect to FIG. 6). Path monitoring/removal is performed in step S520 (step S520 is described in greater detail below with respect to FIG. 7). During this step, a degree of the current status is determined by taking previously determined statuses for the propagation path 330 into account. Step S520 also determines a condition of the path, such as stable, unstable or whether to disable (i.e., stop monitoring) the propagation path 330 based on the determined degree of the status.

FIG. 6 illustrates a flow chart of the conventional status determining step S515 of FIG. 5. The path management unit 370 acquires a previously determined status (e.g., from a last iteration of the step S515) for the propagation path 330 in step S605. The previously determined status is either a “good” status or a “bad” status. The “good” or “bad” status of the propagation path 370 may be stored for use in future calculations (e.g., as a binary number). Thus, in a next execution of step S605, a current status (as described below) may become the previously determined status. The previously determined status is evaluated in step S610. If the previously determined status is “good”, the process advances to step S615; otherwise, the process advances to step S630.

In step S615, the LTE calculated for the propagation path 330 in step S510 of FIG. 5 is compared with a first threshold Bad_Thresh. The first threshold Bad_Thresh may be selected by a network designer, and typically remains fixed for the duration of operation of the wireless communication system 100 of FIG. 1. If the comparison of step S615 indicates that the LTE is greater than the first threshold Bad_Thresh, the process advances to step S625; otherwise, the process advances to step S620. In step S620, a current status for the propagation path 330 is set to “bad”. In step S625, the current status for the propagation path 330 is set to “good”. After the current status is set to one of “good” and “bad” in step 620/625, the process ends at step S645. When the process of FIG. 6 ends at S645, the process of FIG. 5 advances from step S515 to step S520.

In step S630, the LTE calculated for the propagation path 330 in step S510 of FIG. 5 is compared with a second threshold Good_Thresh. The second threshold Good_Thresh may be selected by a network designer, and typically remains fixed for the duration of operation of the wireless communication system 100 of FIG. 1. The first threshold Bad_Thresh is typically selected as a larger number than the second threshold Good_Thresh. If the comparison of step S630 indicates that the LTE is greater than the second threshold Good_Thresh, the process advances to step S640; otherwise, the process advances to step S635. In step S635, a current status for the propagation path 330 is set to “bad”. In step S640, the current status for the propagation path 330 is set to “good”. After the current status is set to one of “good” and “bad” in step 635/640, the process ends at step S645. When the process ends at S645, the process of FIG. 5 advances from step S515 to step S520.

FIG. 7 illustrates a flow chart of the conventional path monitoring/removal step S520 of FIG. 5. The path management unit 370 may continuously monitor propagation paths, e.g., including the propagation path 330. All monitored propagation paths are typically sorted in a list or scheduling queue and analyzed sequentially. In step S705, the path management unit 370 arrives at the propagation path 330 in the sequential analysis of the scheduling queue. In step S710, the process advances to step S780 if the propagation path 330 is not enabled; otherwise, the process advances to step S715. In step S780, the path management unit 370 determines whether additional propagation paths on the scheduling queue require analysis. If so, the process returns to step S705 for consideration of a next path on the scheduling queue; otherwise, the process terminates at step S785 and the process of FIG. 5 advances from step S520, which completes the process of FIG. 5, and causes the process of FIG. 4 to advance from step S410 to step S415.

The current status of the propagation path 330 is evaluated in step S715. If the current status is “good” (e.g., as determined in one of steps S625 and S640 of FIG. 6), the process advances to step S745; otherwise, the process advances to step S720. In step S720, a first counter Bad_Count is compared with a first path condition threshold BadCount_Thresh. The first counter Bad_Count indicates a given number of consecutive times (e.g., consecutive iterations of the process of FIG. 6) the current status has been determined as “bad”. The first path condition threshold BadCount_Thresh is a maximum value for the first counter Bad_Count. The first path condition threshold BadCount_Thresh is a fixed value typically set by a network designer and remains fixed throughout the duration of operation for the wireless communication system 100 of FIG. 1. If the first counter Bad_Count is less than the first path condition threshold BadCount_Thresh, the propagation path 330 is determined to be unstable in step S730, the first counter Bad_Count is incremented (e.g., by one) in step S735, a second counter Good_Count (discussed below) is initialized in step S740, and the process advances to step S780 (described above).

If, in step S720, the first counter Bad_Count is not less than the first path condition threshold BadCount_Thresh (e.g., the first counter Bad_Count is equal to or greater than the first path condition threshold BadCount_Thresh) in step S720, the propagation path 330 is disabled in step S725 and is withdrawn from consideration at the receiver 350. After the propagation path is disabled in step S725, the process advances to step S780 (described above).

As discussed above, the process advances to step S745 if the current status of the propagation path 330 is “good” in step S715. In step S745, the second counter Good_Count is compared with a second path condition threshold GoodCount_Thresh. The second counter Good_Count indicates a given number of consecutive times (e.g., consecutive iterations of the process of FIG. 6) the current status has been determined as “good”. The second path condition threshold GoodCount_Thresh is a fixed value typically set by a network designer and remains fixed throughout the duration of operation for the wireless communication system 100 of FIG. 1. If the second counter Good_Count is less than the second path condition threshold GoodCount_Thresh, the second counter Good_Count is incremented (e.g., by one) in step S750, the first counter Bad_Count is initialized (e.g., set to zero) in step S760 and the path management unit 370 determines whether to evaluate other propagation paths in step S780 (described above). Otherwise, if the second counter Good_Count is not less than the second path condition threshold GoodCount_Thresh, the propagation path 330 is considered stable in step S755, the first counter Bad_Count is initialized (e.g., set to zero) in step S760, and the path management unit 370 determines whether to evaluate other propagation paths in step S780 (described above).

The selection of the first and second path condition thresholds BadCount_Thresh and GoodCount_Thresh may significantly affect the performance of communication between the transmitter 300 (e.g., UE 105, UE 110, etc.) and the receiver 350 (e.g., Node B 120, Node B 122, Node B 124, etc.) in the wireless communication system 100 of FIG. 1. For example, if “good” propagation paths are erroneously filtered or removed, the communication will be delayed while the “good” propagation path is reestablished (e.g., monitored by the receiver 350). Likewise, if “bad” propagation paths are not filtered or removed, the communication between the transmitter 300 and the receiver 350 may deteriorate (e.g., because the communication may include a higher number of error bits, a lower signal-to-noise ratio (SNR), etc.).

### SUMMARY OF THE INVENTION

An example embodiment of the present invention is directed to a method of path monitoring in a wireless communication system operating in accordance with a wireless communication protocol, for example UMTS or CDMA2000. At least one path condition threshold is adjusted for a propagation path received from a mobile based on a signal parameter of the propagation path. A condition of the propagation path is determined based at least in part on the at least one path condition threshold.

### BRIEF DESCRIPTION OF THE DRAWINGS

The present invention will become more fully understood from the detailed description given herein below and the accompanying drawings which are given by way of illustration only, wherein like reference numerals designate corresponding parts in the various drawings, and wherein:

FIG. 1 illustrates a conventional wireless communication system 100 operating in accordance with UMTS protocols.

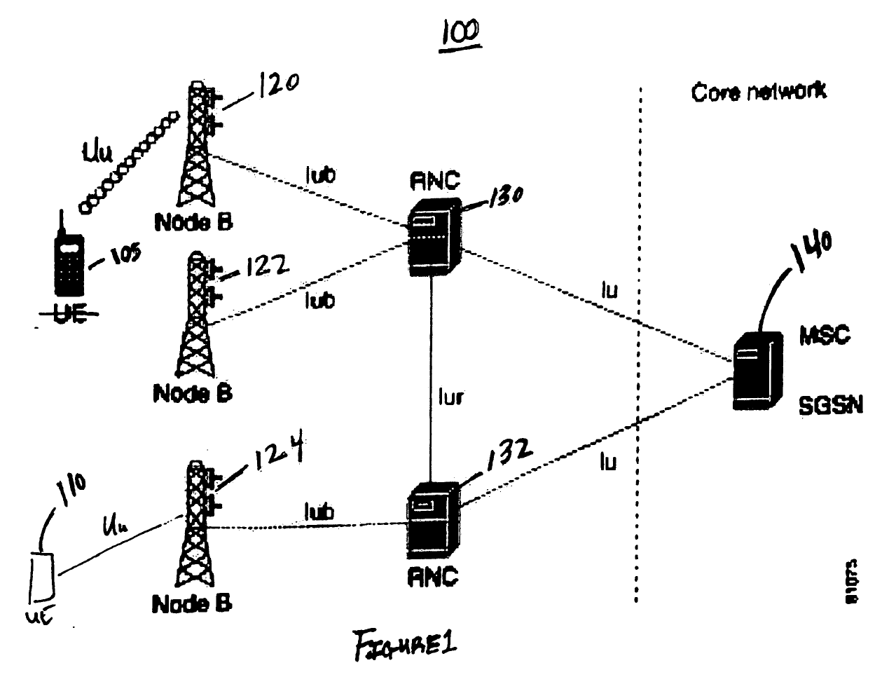

FIG. 2 illustrates an example of a conventional frame structure of uplink dedicated physical channels.

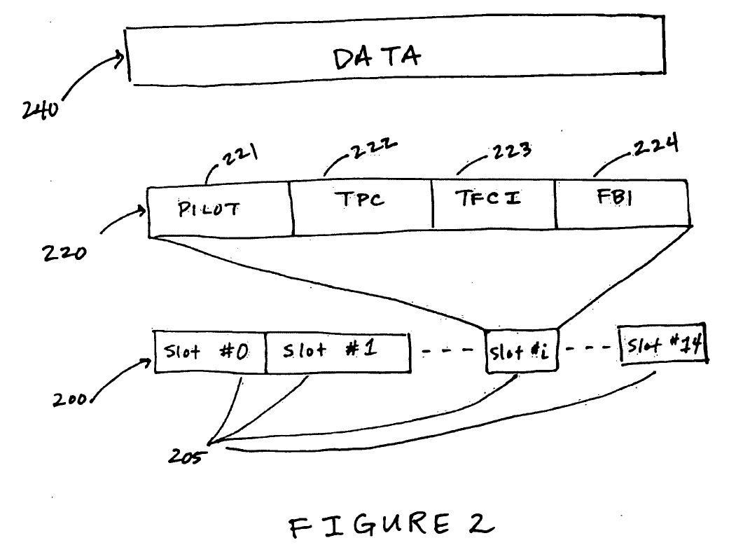

FIG. 3 illustrates a conventional UMTS uplink transmitter and receiver.

FIG. 4 illustrates a flow chart of a conventional operation of a path management unit.

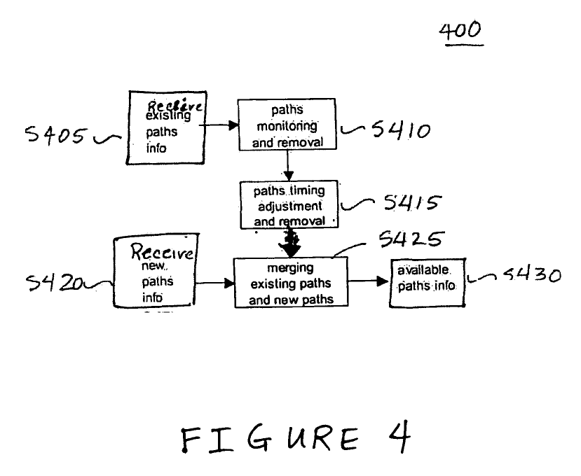

FIG. 5 illustrates a flow chart of the conventional filtering operation of FIG. 4.

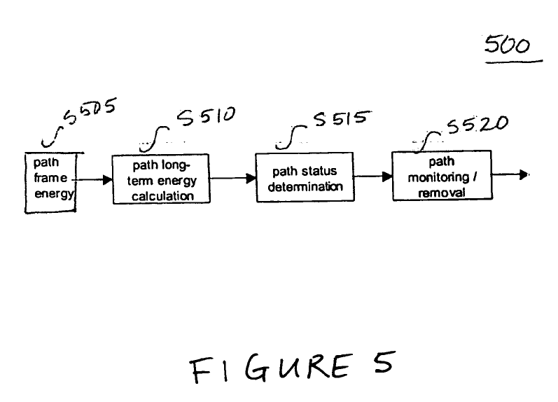

FIG. 6 illustrates a flow chart of the conventional current status determining step of FIG. 5.

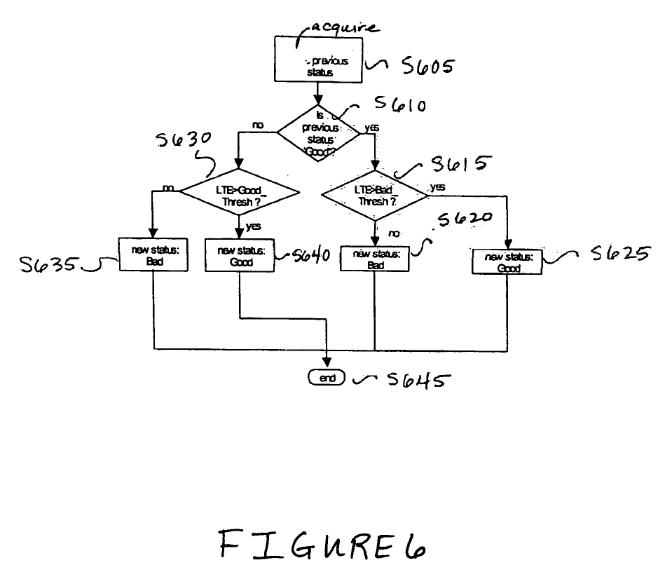

FIG. 7 illustrates a flow chart of the conventional path monitoring/removal step of FIG. 5.

FIG. 8 illustrates a flow chart for handling a path condition threshold adjustment according to an example embodiment of the present invention.

### DETAILED DESCRIPTION OF THE INVENTION

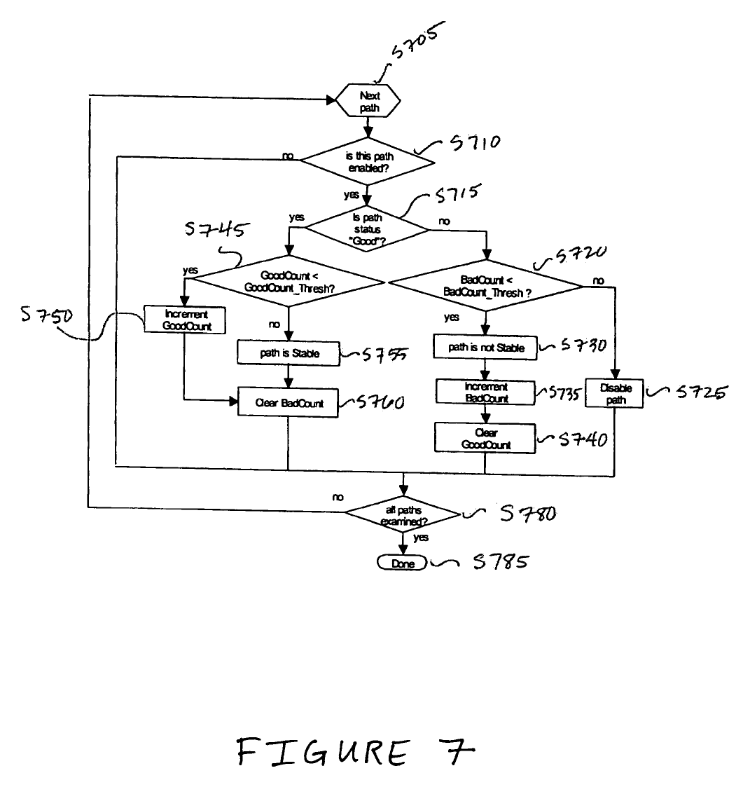

While the above-described conventional method of determining whether to disable the propagation path 330 as illustrated in FIG. 7 employs fixed, predetermined values for the first path condition threshold BadCount_Thresh and the second path condition threshold GoodCount_Thresh, example embodiments of the present invention are directed to adjusting the first path condition threshold BadCount_Thresh and/or the second path condition threshold GoodCount_Thresh based at least in part on a signal parameter of the propagation path 330.

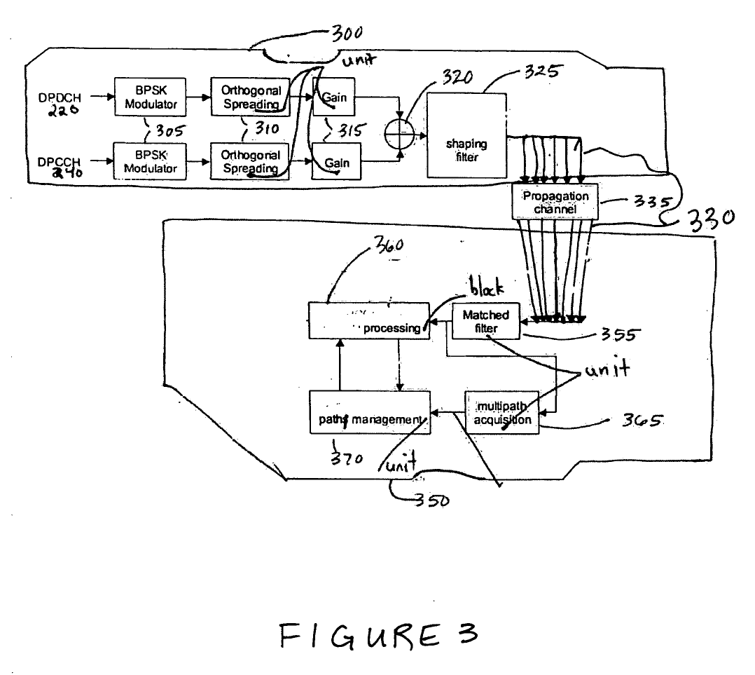

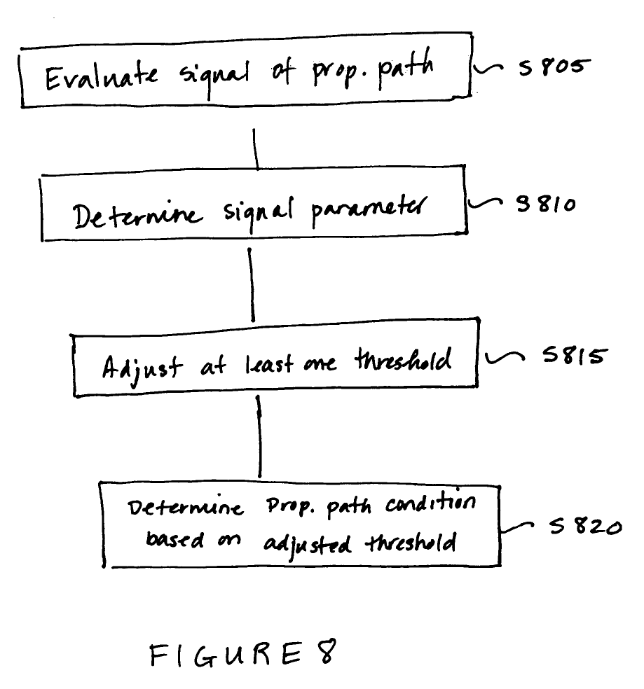

FIG. 8 illustrates a flow chart for handling a path condition threshold adjustment according to an example embodiment of the present invention. A signal received on a propagation path (e.g., propagation path 330) is evaluated (e.g., at the processing block 360 of FIG. 3). Based on the evaluation, at least one signal parameter is determined in step S810. For example, the at least one signal parameter may include a mobility or speed of the UE 105/110 from which the signal is received, as inferred from a mobility indicator. The mobility or Doppler spread may be estimated using any well-known methodologies, for example a Fast Fourier Transform (FFT), a spectral search, etc. At least one of the first and second path condition thresholds BadCount_Thresh and GoodCount_Thresh are adjusted (e.g., increased or decreased) based on the determined at least one signal parameter.

In another example embodiment of the present invention, where the at least one signal parameter includes the mobility indicator for one of the UEs 105/110, the first and second path condition thresholds BadCount_Thresh and GoodCount_Thresh decrease as the mobility indicator for the UE 105/110 increases. Likewise, the first and second path condition thresholds BadCount_Thresh and GoodCount_Thresh increase as the mobility indicator for the UE 105/110 decreases.

Table 1 (below) illustrates an example implementation of the above-described example embodiment. In Table 1, it is assumed that the mobility indicator Mob_Ind (e.g., derived as described above) for the UE 105 or 110 is based on a 2 gigahertz (GHz) carrier frequency.

TABLE 1

| Mob_Ind (in Hertz) | GoodCount_Thresh | BadCount_Thresh |
|---|---|---|
| Mob_Ind < 25 | 8 | 15 |
| 25 <= Mob_Ind < 55 | 6 | 12 |
| 55 <= Mob_Ind < 110 | 5 | 10 |
| 110 <= Mob_Ind < 300 | 4 | 8 |
| 300 < Mob_Ind | 4 | 6 |

However, it is understood that Table 1 is given for example purposes only, and other example embodiments of the present invention may include more or fewer threshold “ranges” based on the mobility indicator. In addition, other parameters, such as the measured signal-to-noise ratio for the path, may be used, either independently or in conjunction with the above-described mobility indicator, to further fine-tune the thresholds.

A condition of the propagation path 330 (e.g., whether the propagation path 330 is stable, unstable, acceptable, unacceptable, disabled, enabled, etc.) may be determined based on at least one of the first and second adjusted path condition thresholds BadCount_Thresh and GoodCount_Thresh in step S820 (e.g., by deployment in the above-described conventional process of FIG. 7).

### EXAMPLE APPLICATIONS

Example applications of the adjusted first and second path condition thresholds will now be given.

In an example incorporating the adjusted path condition thresholds of step S815, a user of the UE 105 is driving a car at a high speed and is communicating with the Node B 124 on propagation path 330. The first and second path condition thresholds BadCount_Thresh and GoodCount_Thresh are reduced or maintained at a lower level as the car increases speed (Steps S805/S810/S815). Thus, as the car leaves the coverage area of the Node B 124, the propagation path 330 is disabled sooner as compared to if the Node B 124 used the previous, higher values for the first and second path condition thresholds BadCount_Thresh and GoodCount_Thresh (Step S820).

In another example, a user of the UE 105 is walking down a street at a slow speed and is communicating with the Node B 124 on propagation path 330. The first and second path condition threshold BadCount_Thresh and GoodCount_Thresh are increased or maintained at a higher level as the user walks at the slow speed (Step S805/S810/S815). Next, assume the user walks into a geographic area (e.g., between buildings) where interference temporarily creates a signal interpreted as having a “bad” status for the propagation path 330. Under this assumption, additional time may be allotted to the slow moving UE 105 to regain a “good” signal because of the increased first path condition threshold BadCount_Thresh because a slow moving UE 105 is more likely to remain within the coverage area for the Node B 124 (Step S820).

The example embodiments of the present invention being thus described, it will be obvious that the same may be varied in many ways. For example, while above-described example embodiments of the present invention are employed in a UMTS wireless communication system, it is understood that other example embodiments of the present invention may be employed in any wireless communication system (e.g., CDMA2000, GSM, etc.). Further, while above-described example embodiments adjust at least one of the first and second path condition thresholds based on a mobility of a given mobile station or UE, it is understood that other example embodiments may adjust at least one of the first and second path condition thresholds (e.g., one or both of the first and second path condition thresholds) based on other signal parameters (e.g., measured signal-to-noise ratio of the path, or other signals from the given mobile station or UE, from another mobile station or UE, from two or more mobile stations or UE, a geographic location associated with the given mobile station or UE, etc.).

Such variations are not to be regarded as a departure from the spirit and scope of the exemplary embodiments of the invention, and all such modifications as would be obvious to one skilled in the art are intended to be included within the scope of the invention.

We claim:

1. A method of path monitoring in a wireless communication system operating in accordance with a wireless communication protocol, comprising:
adjusting at least one path condition threshold for a propagation path received from a mobile based on a signal parameter of the propagation path; and
determining a condition of the propagation path based on the at least one path condition threshold.

2. The method of claim 1, wherein the signal parameter indicates a mobility of the mobile.

3. The method of claim 2, wherein the signal parameter is a Doppler spread of the channel.

4. The method of claim 2, wherein the adjusting step increases the at least one path condition threshold as the mobility decreases.

5. The method of claim 2, wherein the adjusting step decreases the at least one path condition threshold as the mobility increases.

6. The method of claim 2, wherein the condition includes whether the propagation path is stable.

7. The method of claim 6, wherein the condition includes whether the propagation path is unacceptable.

8. The method of claim 2, wherein the condition includes whether the propagation path is unacceptable.

9. The method of claim 1, wherein the condition includes whether the propagation path is stable.

10. The method of claim 9, wherein the condition includes whether the propagation path is unacceptable.

11. The method of claim 1, wherein the condition includes whether the propagation path is unacceptable.

12. The method of claim 1, wherein the determining step comprises:
determining a status of the propagation path;
generating an indicator indicating a degree of the determined status based on the determined status;
comparing the degree of the determined status to the at least one path condition threshold; and
determining the condition based on the comparison.

13. The method of claim 12, wherein the determining the status step determines the status based on long-term energy of the signal on the propagation path and a long term energy threshold.

14. The method of claim 13, wherein:
the determining the status step determines the status is good if the long term energy of the signal on the propagation path is greater than the long term energy threshold; and
the generating step generates the indicator indicating a given number of consecutive times the determining the status step determines the status is good.

15. The method of claim 14, wherein the determining the condition step determines the condition is stable if the indicator is greater than or equal to the path condition threshold.

16. The method of claim 13, wherein:
the determining the status step determines the status is bad if the long term energy of the signal on the propagation path is smaller than the long term energy threshold; and
the generating step generates the indicator indicating a given number of consecutive times the determining the status step determines the status is bad.

17. The method of claim 16, wherein the determining the condition step determines the condition is unstable if the indicator is less than the path condition threshold.

18. The method of claim 17, wherein the determining the condition step determines to disable the propagation path if the indicator is greater than or equal to the path condition threshold.

19. The method of claim 16, wherein the determining the condition step determines to disable the propagation path if the indicator is greater than or equal to the path condition threshold.
